(19) United States
(12) Patent Application Publication
(10) Pub. No.: US 2004/0252611 A1
(43) Pub. Date: Dec. 16, 2004

(54) Disk reproducing device

(75) Inventor: Shigehiro Yoshida, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI DENKI KABUSHIKI KAISHA

(21) Appl. No.: 10/834,835

(22) Filed: Apr. 30, 2004

(30) Foreign Application Priority Data
Jun. 10, 2003 (JP) 2003-165327

(51) Int. Cl. G11B 5/58

(52) U.S. Cl. 369/53.2; 369/53.31

(57) ABSTRACT

A disk reproducing device in which a first control part of a first microprocessor determines whether or not the inserted CD is a CD based on the standard specification for CD on the basis of TOC information and track information which are recorded on an inserted CD, and If the first control means determines that the inserted CD is not a CD based on the standard specification, the first control part provides a notification that the inserted CD is a CCCD which is out of the standard specification by a display through a second communication part and a second control part.

### BACKGROUND OF THE INVENTION

1. Field of the Invention

This invention relates to a disk reproducing device that determines whether or not a compact disk (hereinafter referred to as “CD”) to be reproduced conforms to a CD standard specification and provides a notification when the CD is out of the standard specification.

2. Description of the Related Art

The performances and characteristics of audio CD of high audio quality are standardized by International Electrotechnical Commission (IEC), Japan Industrial Standards (JIS) and the like, and these standards are described in standard specification books, popularly called “RedBook”. Hereinafter, this standard is referred to as “standard specification” or only “standard” in the drawing.

The copy control of CD has been conventionally performed within a range conforming to the above described standard specification. That is to say, this standard specification stipulates that if a CD has “0010” in a control data portion of four bits in the information data of a sub-code Q channel recorded in a track area, copying of the CD is allowed and that if the CD has “0000” in the control data portion, the copying of the CD is not allowed.

However, with the widespread use of personal computers in recent years, illegal copies or illegal reproductions by a CD-ROM drive of the personal computers have been increasing.

In order to cope with the illegal copies and the like, CD so-called “CCCD (Copy Control Compact disk)” which is subjected to copy control by a method that stretches meaning of the standard specification and deviates from the standard specification, have come on market.

The above CCCD is not a kind of illegal CD such as so-called CD pirated edition, but is a kind of CD out of the standard specification.

As a conventional technology related to this CCCD and coping with the illegal copy by the personal computer and the like, there has been proposed a technology in which “0010” and “0000” are alternately put with a repeated manner in the control data portion of the above described sub-code Q channel information data in order to prevent the CCCD from being copied (for example, see patent document 1). [Patent Document 1 Japanese Unexamined Patent Publication No. 2000-215461

The above described copy prevention technology which is produced by stretching the standard specification of CD and is named CCCD, has been employed in the related art in order to prevent the illegal copying of CD.

For this reason, there is presented a problem that some of disk reproducing devices in use can not reproduce the CCCD. In particular, about disk reproducing devices of vehicle-mounted type, the devices in which a navigation function is incorporated, have increased in number. In this case, there are many examples in which the vehicle-mounted disk reproducing device employs a CD-ROM drive for personal computer in order to read map data and the like for navigation system. The device of this kind cannot reproduce the CCCD in some cases.

A reason of this impossibility of reproduction for the CCCD is caused by that the CCCD deviates from the essential standard specification and should not be ascribed to the disk reproducing device itself. However, in many cases, users recognize by mistake that this is ascribed to the failure of the disk reproducing device. By this mis-recognition, it is presented a problem of impairing reliability to quality of the disk reproducing device.

### SUMMARY OF THE INVENTION

The present invention has been made to solve the above described problem and an object of the present invention is to provide a disk reproducing device that notifies a user that an inserted CD is out of the standard specification when the inserted CD is a CCCD and prevents the user from recognizing by mistake that the disk reproducing device is faulty to prevent reliability to the quality of the device from being impaired.

A disk reproducing device in accordance with the present invention includes: standard determination means that determines on the basis of information recorded on an inserted compact disk whether or not the inserted compact disk is a compact disk based on a standard specification; and notification means that provides a notification of the inserted compact disk being out of the standard specification when the standard determination means determines that the inserted compact disk is not a compact disk based on the standard specification.

Therefore, according to the present invention, even if the inserted CD cannot be reproduced because it is a CCCD which is out of the standard specification, it is possible to prevent the user from recognizing by mistake that the disk reproducing device is faulty and hence to prevent reliability to quality of the device from being impaired.

### BRIEF DESCRIPTION OF THE DRAWINGS

FIG. 1 is a block diagram to show the structure of a disk reproducing device in accordance with embodiment 1 of the present invention.

FIG. 2 is a flow chart for determining whether or not an inserted CD is a CD of the standard specification for embodiment 1 of the present invention.

FIG. 3 is a diagram to show a data structure of the TOC information recorded in a lead-in area of the innermost periphery of the CD.

FIG. 4 is a diagram to show a partial detailed view of data structure of the TOC information in FIG. 3.

FIG. 5 is a diagram to show a data structure of a sub-code Q channel recorded in a track area of the CD.

FIG. 6 is a diagram to show a partial detailed view of data structure of the sub-code Q channel recorded in FIG. 5.

FIG. 7 is a diagram to show a partial detailed view of data structure of the sub-code Q channel recorded in FIG. 6.

### DETAILED DESCRIPTION OF THE PREFERRED EMBODIMENTS

A preferred embodiment of the present invention will be described in detail below.

### EMBODIMENT 1

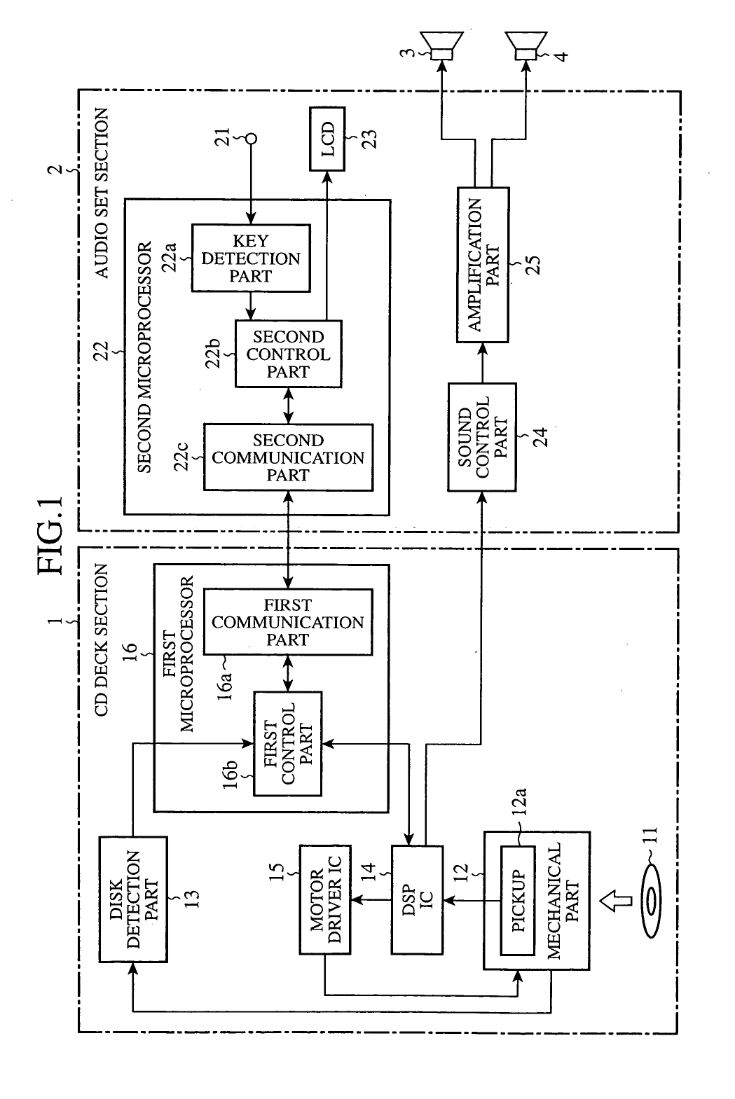

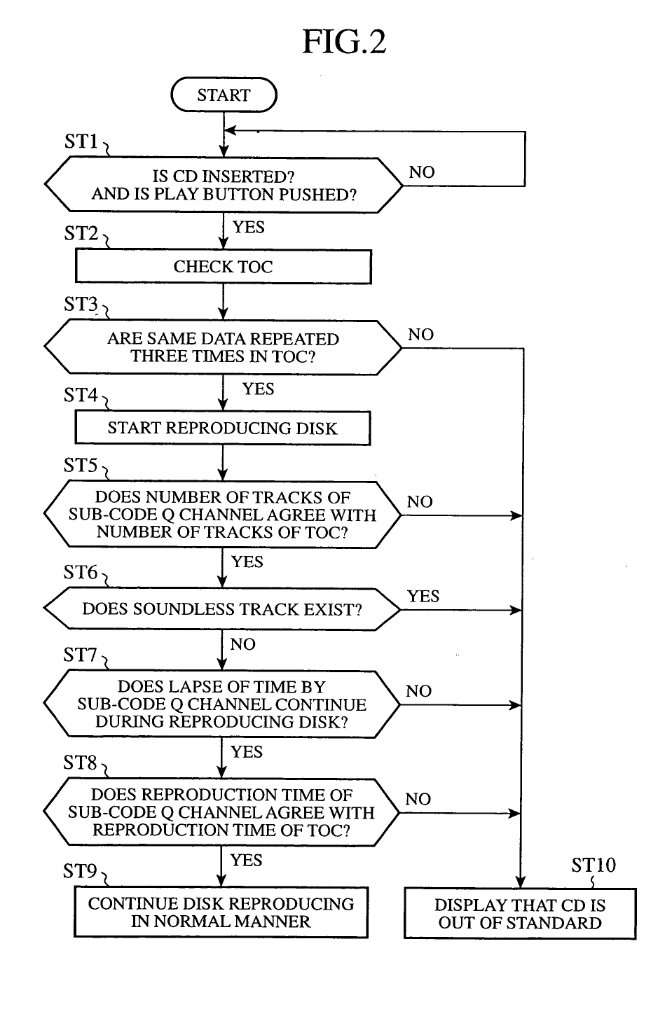

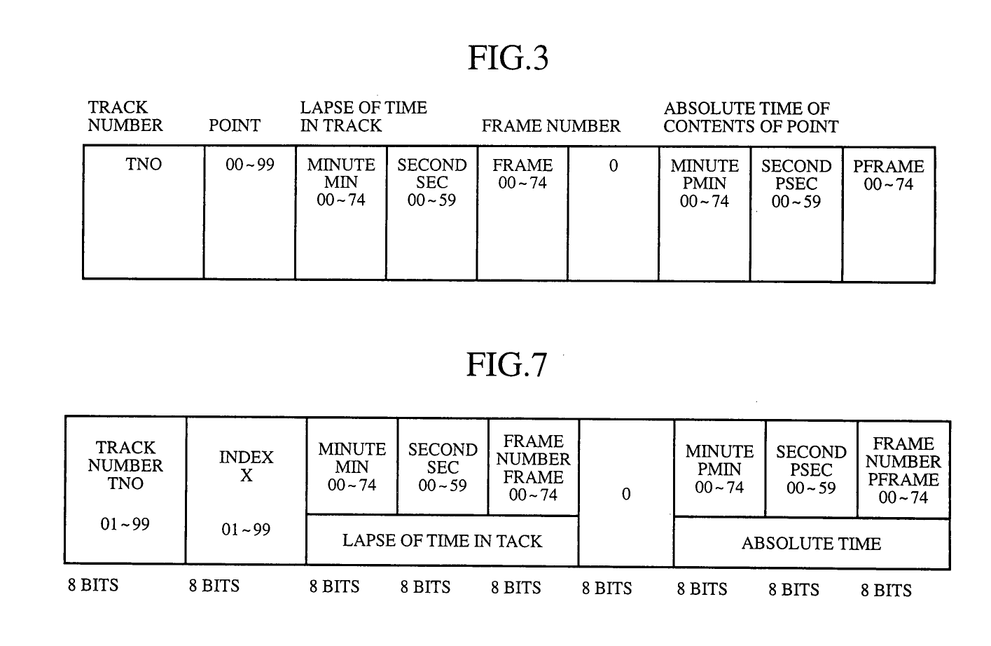

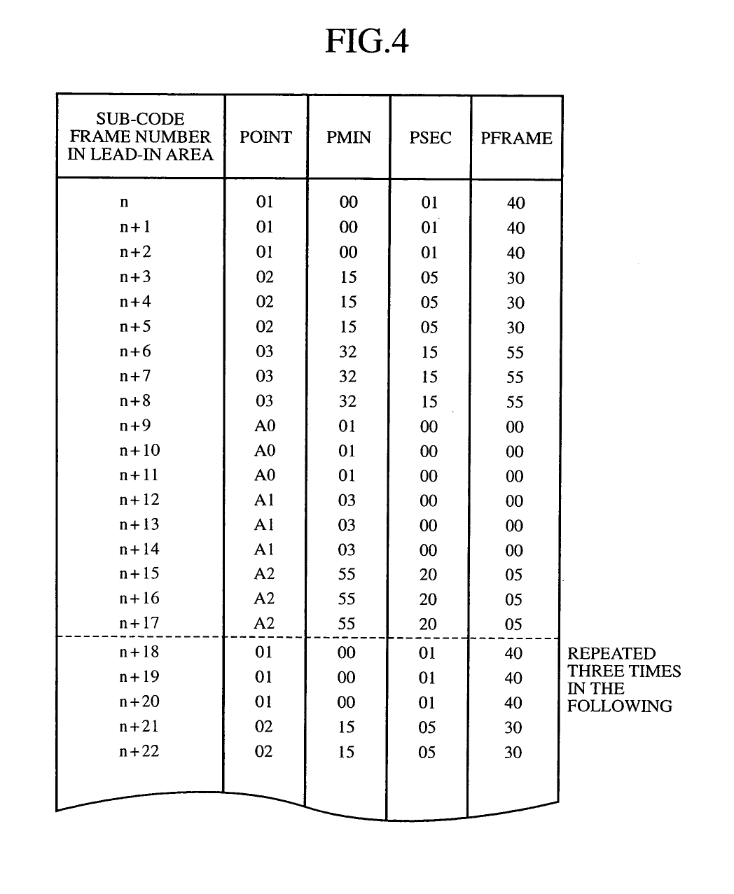

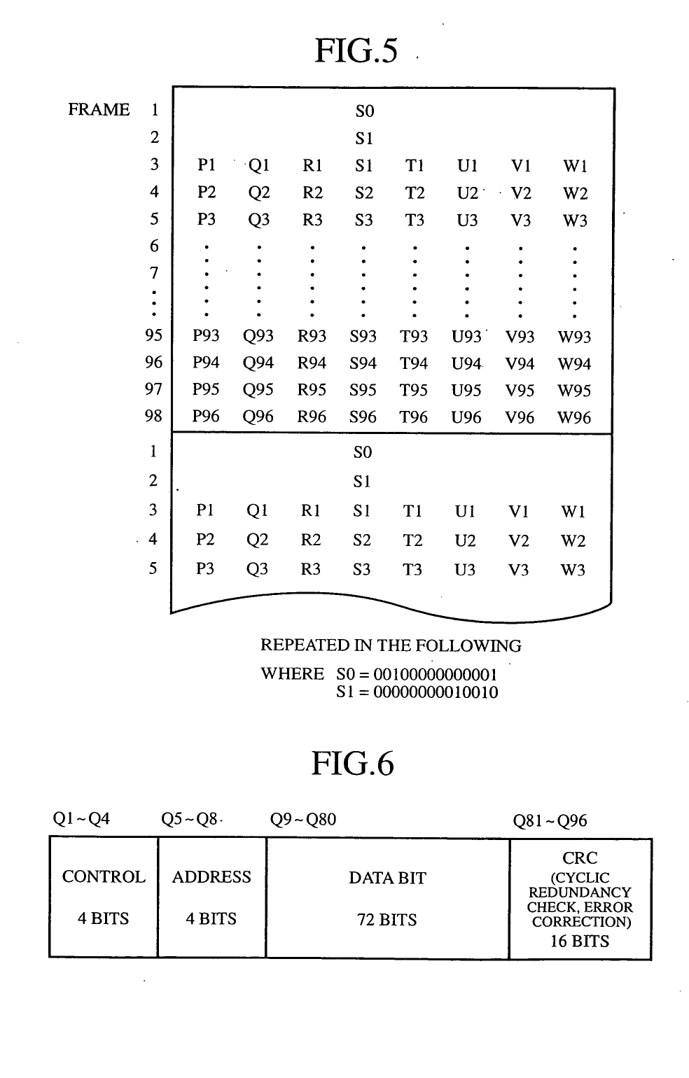

FIG. 1 is a block diagram to show the structure of a disk reproducing device in accordance with embodiment 1 of the present invention. FIG. 2 is a flow chart for determining whether or not an inserted CD is a CD of the standard specification. FIG. 3 and FIG. 4 are diagrams to show data structure of the table of contents (hereinafter referred to as “TOC”) information recorded in a lead-in area of the innermost periphery of the CD as recorded information of the disk. FIG. 5 to FIG. 7 are diagrams to show data structure of a sub-code Q channel recorded in a track area.

In FIG. 1, a disk reproducing device is composed with a CD deck section 1, an audio set section 2, and left and right speakers 3, 4.

The CD deck section 1 includes a mechanical part 12 into which a CD 11 is inserted and which is provided with a pickup 12a for reading information from this CD 11, a disk detection part 13 for detecting that the CD 11 is inserted into the mechanical part 12, a DSP (Digital Signal Processor) IC 14 for performing servo control and signal processing of the CD deck section 1, a motor driver IC 15 for driving the mechanical part 12 on the basis of the servo control signal from the DSP IC 14, and a first microprocessor 16 provided with a first communication part 16a and a first control part 16b that controls the whole of the CD deck section 1 and also acts as standard determination means.

Moreover, the audio set section 2 includes a PLAY button 21, a second microprocessor 22 provided with a key detection part 22a for detecting this PLAY button 21 being pushed and a second control part 22b and a second communication part 22c, an LCD (liquid crystal display) 23 as notification means, a sound control part 24 for controlling reproduced sound data from the CD deck section 1, and an amplification part 25 for amplifying sound and driving speakers 3, 4.

Next, operation of disk reproducing device in FIG. 1 will be described according to the flow chart in FIG. 2 with reference to FIGS. 3 to 7.

In FIG. 2, at step ST1, it is determined whether or not the CD 11 is inserted into the mechanical part 12 of CD deck section 1 and whether or not the PLAY button 21 is pushed.

This determination is made by the first control part 16b of the first microprocessor 16 from the following signal to be input.

In a case where the CD 11 is inserted, the disk detection part 13 detects the CD 11 being inserted and a detection signal thereof is input to the first control part 16b.

Moreover, in a case where the PLAY button 21 is pushed, the key detection part 22a of the second microprocessor 22 detects the PLAY button 12 being pushed and a detection signal thereof is transmitted by the second control part 22c of the second microprocessor 22 to the first control part 16a of the first microprocessor 16 through the second communication part 22c and is input to the first control part 16b through the first communication part 16a.

If it is determined at step ST1 that the CD 11 is inserted and that the PLAY button 21 is pushed, the routine proceeds to step ST2.

At step ST2, the first control part 16b controls the motor driver IC 15 via the DSP IC 14 to drive the mechanical part 12 in order to make the pickup 12a read TOC information from the CD 11. The TOC information read by the pickup 12a is input through the DSP IC 14 to the first control part 16b and the first control part 16b checks the TOC information.

At this point, an explanation about the TOC will be described.

The audio CD has an outer diameter of 12 cm or 8 cm and is provided with a continuous helical track path extending from the inner peripheral side of the disk to the outer peripheral side and the data of various kinds of information is recorded with a frame structure in this track path. Here, serial frame numbers are assigned to the respective frames from the inner peripheral side.

Moreover, an area for recording information is broadly divided into three areas of a lead-in area provided at the innermost periphery, a program area provided next to the lead-in area toward the outer peripheral side, and a lead-out area provided next to the program area toward the outer peripheral side.

In the lead-in area is surely recorded the TOC information.

Moreover, the program area is divided into a plurality of tracks and each track corresponds to a piece of music in ordinary cases. In these respective tracks are recorded not only the primary data of music and the like but also various kinds (channels) of sub-codes.

The TOC information recorded in the lead-in area corresponds to an index of CD, in which data of a table of pieces of music and the like are recorded, and is composed with various kinds of data as shown in FIG. 3. In the drawing, each of square portions is formed of 8 bits and the TOC information is data formed of a total of 72 bits.

In this respect, “point” in FIG. 3 means a data of positions which starts at a starting point of the first track and ends at the last track, and “lapse of time” means a lapse of time in each track, and “absolute time” means time that elapses from the starting point of the first track to the starting point of each track shown by the point. “PFRAME” is a unit obtained by dividing one second into equal 75 parts.

FIG. 4 is a diagram to show an example of data about a relationship between the sub-coding frame number recorded in the lead-in area and the “point” and the “absolute times (PMIN, PSEC, PRRAME) of the contents of point”.

At this point, the numerals shown in the drawing are mere examples, and A0 designates a position of the first piece of music, A1 designates a position of the last piece of music, and A2 designates a starting position of the lead-out area.

An important point in this FIG. 4 is that in a CD based on the standard specification, same data from the n-th frame to the (n+17)-th frame is surely repeated three times.

In contrast to this, the CCCD which is out of the standard specification (of non-standard) deviates from this prescription. For example, there is a case where TOC has false information in the frames of one of three times or of all of three frames.

Hence, it can be determined by checking the difference in the TOC information, whether a CD is based on the standard specification or is out of the standard specification. That is, whether or not the same data is repeated three times is a determination criterion for whether or not a CD is based on the standard specification.

At step ST3, the first control part 16b determines whether or not the same data are repeated in the TOC three times as described above. If the same data are repeated three times, the first control part 16b determines that the CD is based on the standard specification and the routine proceeds to step ST4. If the same data is not repeated three times, the first control part 16b determines that the CD will probably be a CCCD which is out of the standard specification and the routine proceeds to step ST10. The step ST10 will be described later.

At step ST4, the first control part 16b controls the motor driver IC 15 via the DSP IC 14 to operate the pickup 12a of the mechanical part 12 and to start reproducing the CD 11.

When the pickup 12a starts reproducing the CD 11, the pickup 12a reads information from the track next to the lead-in area.

At step ST5, the first control part 16b takes notice of data in the sub-code Q channel in the track information.

Hereinafter, an explanation about this sub-code Q channel will be described.

In the sub-code recorded in the track, as shown in FIG. 5, 8 kinds (channels) of P, Q, R, . . . , and W are stipulated and each of these channels P to W is given one bit.

Moreover, in each of these channels (P to W) of the sub-code, one frame is composed with 96 symbols: for example, a Q channel is composed with 96 bits of from Q1 to Q96.

In this respect, “S0” and “S1” in FIG. 5 are synchronous data and “S0” is data having a structure of “00100000000001” and “S1” is data having a structure of “00000000010010”.

It is the Q channel that is the most important in the above described sub-code and it is FIG. 6 that shows the detailed breakdown of 96 bits of from Q1 to Q96. The 72 bits from Q9 to Q80 in FIG. 6 are called data bits and it is FIG. 7 that shows the detailed breakdown of data bits formed of these 72 bits.

As shown in FIG. 7, in the data of sub-code Q channel it is included information of the lapse of time and the absolute time-and the like corresponding to the track number.

The standard specification stipulates that a CD conforming to the standard specification has these data structure shown in FIG. 7 and that the data in FIG. 7 agrees with the TOC data in FIG. 3.

In contrast to this, a CCCD which is out of the standard specification, deviates from this stipulation.

Therefore, it is possible to determine whether the inserted CD is a CD of the standard specification or a CD out of the standard specification from the data of sub-code Q channel and the TOC data.

At step ST5, the first control part 16b determines whether or not the number of tracks of sub-code Q channel agrees with the number of tracks of TOC. If it is determined that the number of tracks of sub-code Q channel agrees with the number of tracks of TOC, it is determined that the CD is based on the standard specification and the routine proceeds step ST6. If it is determined that the track number of sub-code Q channel does not agree with the track number of TOC, it is determined that the CD will probably be a CCCD which is out of the standard specification and the routine proceeds step ST10.

For example, if a part of or the whole of TOC is false TOC, the track number of sub-code Q channel does not agree with the track number of TOC.

At step ST6, the first control part 16b determines whether or not a soundless state is brought about during the reproducing of data by a soundless track in which data to be reproduced does not exist due to existence of soundless track. If it is determined that the soundless state is not brought about, it is determined that the CD is based on the standard specification and the routine proceeds step ST7. If it is determined that the soundless state is brought about, it is determined that the CD will probably be a CCCD which is out of the standard specification and the routine proceeds step ST10.

The reason why this soundless state is employed as a determination criterion, is because it is surely confirmed that such a CCCD really exists.

In this case, the first control part 16b searches the data to be reproduced for a soundless track and when the first control part 16b finds that the soundless track exists in the data to be reproduced, the routine proceeds to step ST10 as described above.

At step ST7, the first control part 16b determines whether or not the data of a lapse of time in the track in the sub-code Q channel is a data with continuing time during the reproducing of data. If it is determined that the data of lapse of time in the track in the sub-code Q channel is the data with continuing time, it is determined that the CD is based on the standard specification and the routine proceeds step ST8. If it is determined that the data of a lapse of time in the track in the sub-code Q channel is not the data with continuing time, it is determined that the CD will probably be a CCCD which is out of the standard specification and the routine proceeds step ST10.

The standard specification stipulates that in a CD based on the standard specification, the lapse of time in the track shown in FIG. 7 is continuing.

In contrast to this, in a CCCD which is out of the standard specification there is a case where the above described time is not continuing, for example, because the data of the above described time is not recorded.

At step ST8, the first control part 16b determines whether or not the lapse of time in the track in the sub-code Q channel, that is, the reproduction time agree with the lapse of time in the track of TOC, that is, the reproduction time. If it is determined that the reproduction time in the sub-code Q channel agrees with the reproduction time of TOC, it is determined that the CD is based on the standard specification and the routine proceeds step ST9. If it is determined that the reproduction time in the sub-code Q channel does not agree with the reproduction time of TOC, it is determined that the CD will probably be a CCCD which is out of the standard specification and the routine proceeds step ST10.

For example, if a part of or the whole of TOC is false TOC, the reproduction time in the sub-code Q channel does not agree with the reproduction time of TOC.

At step ST9, the first control part 16b determines that the inserted CD is a CD based on the standard specification and continues reproducing the CD in normal manner.

With this arrangement, the sound data to be reproduced that is read from the CD 11 by the pickup 12a is input through the DSP IC 14 to the sound control part 24 of the audio set part 2 and is amplified by the amplification part 25 and is reproduced by the speakers 3, 4.

At step ST10, the first control part 16b determines that the inserted CD will probably be a CCCD which is out of the standard specification and issues a command of displaying that the CD is out of the standard specification.

The above described determination result by the first control part 16b is sent as a signal of, for example, “detection of disk out of the standard specification” from the first control part 16a through the second communication part 22c of the audio set section 2 to the second control part 22b thereof. The second control pat 22b provides a notification of literal display of “detection of disk out of standard specification” by the LCD 23 as notification means.

In this respect, the above described notification means is not limited to the LCD 23, but the notification may be provided by lighting an LED (light emitting diode) or by sound or voice.

In addition, in FIG. 2 described above, as for determinations at steps ST3, ST5, ST6, ST7, and ST8, depending on the technical trends in CCCD in the future, the determinations are not always made for all of these five steps, but the determination flow may be employed in which the determinations are made in combination at arbitrary steps appropriately selected from these five steps.

As described above, according to this embodiment 1, the disk reproducing device is made in such a way that the first control part 16b of the first microprocessor 16 determines whether or not the inserted CD is a CD based on the standard specification on the basis of the TOC information and the track information, and that the first control part 16b provides a notification to the effect that the CD is out of the standard specification by the LCD 23 if the inserted CD is not a CD based on the standard specification. Therefore, even if the inserted CD cannot be reproduced because it is a CCCD which is out of the standard specification, it is possible to prevent the user from recognizing by mistake that the device is faulty and hence to prevent reliability to the quality of the device from being impaired.

What is claimed is:

1. A disk reproducing device that reads TOC information recorded in a lead-in area of an inserted compact disk and track information recorded in a track thereof and reproduces the inserted compact disk, the disk reproducing device comprising:
standard determination means that determines on the basis of information recorded on the inserted compact disk whether or not the inserted compact disk is a compact disk based on a standard specification; and
notification means that provides a notification of the inserted compact disk being out of the standard specification when the standard determination means determines that the inserted compact disk is not a compact disk based on the standard specification.

2. The disk reproducing device as claimed in claim 1, wherein the standard determination means determines that the inserted compact disk is not a compact disk based on the standard specification when the TOC information is not composed in such a way that data of same contents are repeated three times in every predetermined number of frames.

3. The disk reproducing device as claimed in claim 1, wherein the standard determination means determines that the inserted compact disk is not a compact disk based on the standard specification when the number of tracks in the TOC information does not agree with the number of tracks in the track information.

4. The disk reproducing device as claimed in claim 1, wherein the standard determination means determines that the inserted compact disk is not a compact disk based on the standard specification when a soundless track having no data to be reproduced exists.

5. The disk reproducing device as claimed in claim 1, wherein the standard determination means determines that the inserted compact disk is not a compact disk based on the standard specification when data of a lapse of time in the track of a sub-code Q channel in the track information is not a data with continuing time.

6. The disk reproducing device as claimed in claim 1, wherein the standard determination means determines that the inserted compact disk is not a compact disk based on the standard specification when data of reproduction time in the TOC information does not agree with data of reproduction time in the track information.

7. A disk reproducing device that reads TOC information recorded in a lead-in area of an inserted compact disk and track information recorded in a track thereof and reproduces the inserted compact disk, the disk reproducing device comprising:
standard determination means that determines on the basis of said TOC information and said track information whether or not the inserted compact disk is a compact disk based on a standard specification; and
notification means that provides a notification of the inserted compact disk being out of the standard specification when the standard determination means determines that the inserted compact disk is not a compact disk based on the standard specification.

8. The disk reproducing device as claimed in claim 7, wherein the standard determination means determines that the inserted compact disk is not a compact disk based on the standard specification when the TOC information is not composed in such a way that data of same contents are repeated three times in every predetermined number of frames.

9. The disk reproducing device as claimed in claim 7, wherein the standard determination means determines that the inserted compact disk is not a compact disk based on the standard specification when the number of tracks in the TOC information does not agree with the number of tracks in the track information.

10. The disk reproducing device as claimed in claim 7, wherein the standard determination means determines that the inserted compact disk is not a compact disk based on the standard specification when a soundless track having no data to be reproduced exists.

11. The disk reproducing device as claimed in claim 7, wherein the standard determination means determines that the inserted compact disk is not a compact disk based on the standard specification when data of a lapse of time in the track of a sub-code Q channel in the track information is not a data with continuing time.

12. The disk reproducing device as claimed in claim 7, wherein the standard determination means determines that the inserted compact disk is not a compact disk based on the standard specification when data of reproduction time in the TOC information does not agree with data of reproduction time in the track information.
